(19) United States
(12) Patent Application Publication
(10) Pub. No.: US 2016/0296891 A1
(43) Pub. Date: Oct. 13, 2016

(54) ORGANIC/INORGANIC HYBRID MEMBRANE FOR FOULING RESISTANCE, METHOD OF PREPARING MEMBRANE FOR FOULING RESISTANCE, AND WATER TREATMENT DEVICE INCLUDING SAID MEMBRANE

(71) Applicant: Samsung Electronics Co., Ltd., Suwon-si, Gyeonggi-do (KR)

(72) Inventors: Hye Young KONG, Uijeongbu-si (KR); Sung Soo HAN, Hwaseong-si (KR)

(73) Assignee: SAMSUNG ELECTRONICS CO., LTD., Suwon-si, Gyeonggi-do (KR)

(21) Appl. No.: 15/100,905

(22) PCT Filed: Dec. 3, 2014
(86) PCT No.: PCT/KR2014/011774

§ 371 Date: Jun. 1, 2016

(30) Foreign Application Priority Data
Dec. 3, 2013 (KR) 10-2013-0149208

(51) Int. Cl. B01D 69/14; B01D 67/00; B01D 69/02; B01D 71/58; B01D 61/00; B01D 69/12; B01D 65/08; B01D 61/14; B01D 61/02; B01D 71/68; B01D 71/02

(52) U.S. Cl. CPC B01D 69/148; B01D 71/68; B01D 67/0079; B01D 69/02; B01D 71/58; B01D 71/024; B01D 69/12; B01D 65/08; B01D 61/145; B01D 61/025; B01D 61/002; B01D 61/147; B01D 2325/48; B01D 2325/28; B01D 2325/025

(57) ABSTRACT

Disclosed are an organic/inorganic hybrid membrane for fouling resistance including a composite of a hydrophilic inorganic particle and a quaternary ammonium compound dispersed in an organic polymer matrix, a method of preparing the membrane, a separation membrane for water treatment including the membrane, and a water treatment device including the separation membrane for water treatment.

### CROSS REFERENCE TO RELATED APPLICATIONS

This is a National Phase Application of PCT/KR2014/011774, filed Dec. 3, 2014, which is an International Application claiming priority to and the benefit of Korean Patent Application No. 10-2013-0149208 filed in the Korean Intellectual Property Office on Dec. 3, 2013, the entire contents of each of which are incorporated herein by reference.

### TECHNICAL FIELD

An organic/inorganic hybrid membrane for fouling resistance, a method of preparing the membrane for fouling resistance, and a water treatment device including the membrane for fouling resistance are disclosed.

### BACKGROUND ART

Membrane fouling is a significant problem in the membrane industry. It is characterized by a decrease in membrane flux over time, which is generally induced by components in a feed solution passing through the membrane. It may be caused by molecule adsorption in the membrane pores, pore blocking, or cake formation on the membrane surface. A flux reduction increases operation energy use, and to overcome this, cleaning is required. However, this is only a temporary solution, and fouling typically decreases the life-span of the membrane.

As a method for reducing fouling of membranes for reverse osmosis (RO), forward osmosis (FO), ultrafiltration (UF), and microfiltration (MF), a method of coating a fouling resistance material on the surfaces of the membranes have been suggested. However, this method has problems of stability between the surface of membranes and coated antibiotic surfaces, and of peeling off of the coated surface during a water treatment process.

### SUMMARY

One embodiment provides an organic/inorganic hybrid membrane including a hydrophilic inorganic particle and an antibiotic material in an organic polymer matrix.

Another embodiment provides a method of preparing the organic/inorganic hybrid membrane.

Yet another embodiment provides a separation membrane for water treatment including the organic/inorganic hybrid membrane.

Still another embodiment provides a water treatment device including the separation membrane.

In one embodiment, an organic/inorganic hybrid membrane for fouling resistance including a composite of an inorganic nanoparticle and a quaternary ammonium compound represented by the following Chemical Formula 1 is provided, which is dispersed in an organic polymer matrix.

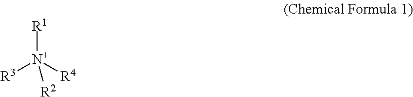

In the above Chemical Formula 1, R¹ to R³ are the same or different, and are independently a C1 to C20 linear or branched alkyl group, and R⁴ is —(CH₂)ₙ—SiR′, wherein R′ is a hydroxy group or a C1 to C6 alkoxy group and n is an integer ranging from 1 to 10.

The inorganic nanoparticle may be an oxide or a hydroxide of Ti, Al, Zr, Si, Sn, B, or Ce.

The organic polymer matrix may be prepared by a material being capable of forming a polymer matrix by a non-solvent induced phase-separation method. For example, the organic polymer matrix may include an organic polymer selected from polysulfone, sulfonated polysulfone, polyethersulfone, polyphenylsulfone, sulfonated polyphenylsulfone, polyetherethersulfone, polyetherketone, polyetheretherketone, polyphenylene ether, polydiphenylphenylene ether, polyphenylene sulfide, cellulose acetate, cellulose diacetate, cellulose triacetate, polyacrylonitrile, and a mixture of two or more thereof, or the foregoing organic polymers substituted with an anionic functional group.

The anionic functional group may be selected from a carboxyl group (—COOH), a sulfonic acid group (—SO₃H), a phosphinic group (—PO₃H₂), a phosphonic group (—HPO₃H), or a nitrous acid group (—NO₂H).

The organic/inorganic hybrid membrane may have a finger-like pore structure.

In another embodiment, a method of preparing an organic/inorganic hybrid membrane for fouling resistance is provided, that includes preparing an inorganic nanoparticle or a precursor of the inorganic nanoparticle, and a quaternary ammonium compound, adding the prepared inorganic nanoparticle or precursor of the inorganic nanoparticle and quaternary ammonium compound in an organic polymer solution to prepare a mixture, and applying a non-solvent induced phase-separation method after casting the mixture on a substrate.

The inorganic particle may be a nanoparticle of an oxide or a hydroxide of Ti, Al, Zr, Si, Sn, B, Ce, or a mixture thereof.

The process of preparing the inorganic nanoparticle or the precursor of the inorganic nanoparticle and the quaternary ammonium compound may include forming an inorganic particle-quaternary ammonium compound composite by coating the surface of the inorganic nanoparticle with the quaternary ammonium compound.

The composite may have a core-shell structure including a core of the inorganic particle and a shell of the quaternary ammonium compound being bound with the core.

Alternatively, the process of preparing the inorganic nanoparticle or the precursor of the inorganic nanoparticle and the quaternary ammonium compound may include preparing the precursor of the inorganic nanoparticle and the quaternary ammonium compound.

The precursor of the inorganic nanoparticle may be an alkoxide, an ester, an acetylacetonate, a halide, or a nitride of a Ti, Al, Zr, Si, Sn, B, or Ce element.

The quaternary ammonium compound may be represented by the following Chemical Formula 1.

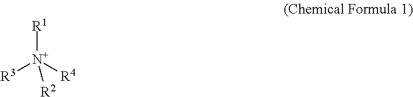

In the above Chemical Formula 1, R¹ to R³ are the same or different, and are independently a C1 to C20 linear or branched alkyl group, and R⁴ is —(CH₂)ₙ—SiR′, wherein R′ is a hydroxy group or a C1 to C6 alkoxy group and n is an integer ranging from 1 to 10.

In yet another embodiment, a separation membrane for water treatment including the organic/inorganic hybrid membrane for fouling resistance is provided.

The organic/inorganic hybrid membrane may be used as a support layer of the separation membrane for water treatment.

The separation membrane for water treatment may be hybrid membrane that further includes a separation layer on one surface of the organic/inorganic hybrid membrane.

The separation layer may be formed on one surface of the organic/inorganic hybrid membrane by interface polymerization.

In still another embodiment, a water treatment device including the separation membrane for water treatment is provided.

The water treatment device may be a forward osmosis water treatment device or a reverse osmosis water treatment device.

The membrane in which hydrophilic inorganic particles and antibiotic material are uniformly dispersed can be used for a prolonged period without reducing water flux due to its improved resistance to contamination. Further, the membrane has improved water permeability by including hydrophilic inorganic particles and finger-like porous structure.

### BRIEF DESCRIPTION OF DRAWINGS

FIG. 1 is a schematic view of an inorganic particle-quaternary ammonium compound composite having a core-shell structure formed by binding a quaternary ammonium compound on the surface of a silica nanoparticle according to Example 1.

FIG. 2 is a scanning transmission electron microscope (STEM) photograph showing the silica nanoparticle-quaternary ammonium compound composite according to Example 1.

FIG. 3 is a scanning electron microscope (SEM) photograph showing the cross-section of a membrane prepared by using sulfonated polyphenylsulfone (SPPS) in a non-solvent induced phase-separation method according to Comparative Example 1.

FIG. 4 is a SEM photograph showing the cross-section of a membrane prepared according to Example 1 by adding the silica nanoparticle-quaternary ammonium compound composite to a sulfonated polyphenylsulfone (SPPS) solution and using a non-solvent induced phase-separation method.

FIG. 5 is a SEM photograph showing the cross-section of the membrane prepared by using polysulfone and using a non-solvent induced phase-separation method according to Comparative Example 2.

FIG. 6 is a SEM photograph showing the cross-section of a membrane prepared by adding tetraethyl orthosilicate (TEOS) as a silica precursor and a quaternary ammonium compound to polysulfone and using a non-solvent induced phase-separation method according to Example 2.

FIG. 7 is a SEM photograph showing the cross-section of a membrane manufactured by adding titanium tetraisopropoxide (TTIP) as a titania precursor and a quaternary ammonium compound to polysulfone and using a non-solvent induced phase-separation method according to Example 3.

FIG. 8 is a SEM photograph showing the cross-section of a membrane prepared by adding only TEOS to polysulfone and using a non-solvent induced phase-separation method according to Comparative Example 3.

FIG. 9 is a SEM photograph showing the cross-section of a membrane prepared by adding only TTIP to polysulfone and using a non-solvent induced phase-separation method according to Comparative Example 4.

FIG. 10 is a SEM photograph showing the cross-section of a membrane prepared by adding only a quaternary ammonium compound to polysulfone and using a non-solvent induced phase-separation method according to Comparative Example 5.

FIG. 11 is a graph comparatively showing the adsorption degree of bovine serum albumin (BSA) on the surface of the membranes according to Example 1 and Comparative Example 1.

FIG. 12 is a graph showing water fluxes and reverse salt fluxes of the membranes according to Example 2 and Comparative Example 2.

FIG. 13 is a graph comparatively showing water fluxes and reverse salt fluxes of the membranes according to Example 3 and Comparative Example 2.

FIG. 14 is a graph comparatively showing water fluxes and reverse salt fluxes of the membranes according to Comparative Examples 2, 3, and 4.

FIG. 15 is a graph comparatively showing water fluxes and reverse salt fluxes of the membranes according to Comparative Examples 2 and 5.

FIG. 16 is a graph showing BSA fouling performance of a hybrid separation membrane respectively including the membranes according to Comparative Example 2 and Example 3 as a support layer on a non-woven fabric and a polyamide separation layer thereon and positioned to contact a feed solution.

FIG. 17 is a graph showing BSA fouling performance of a hybrid membrane respectively including the membranes according to Comparative Example 2 and Example 3 as a support layer and a polyamide separation layer thereon and positioned to contact a draw solution after removing a non-woven fabric.

FIG. 18 is a schematic view showing a forward osmosis water treatment device according to an example embodiment.

### DETAILED DESCRIPTION

The present disclosure will be described more fully hereinafter with reference to the accompanying drawings, in which example embodiments of this disclosure are shown. However, this disclosure may be embodied in many different forms and is not construed as limited to the example embodiments set forth herein.

For clear explanation of the present disclosure, parts unrelated to the present disclosure in the attached drawings are omitted, and the same reference numbers are assigned for the same or similar constituent elements.

The size and thickness of each constituent element as shown in the drawings are randomly indicated for better understanding and ease of description, and this disclosure is not necessarily limited to as shown.

The size and thickness of each constituent element as shown in the drawings are exaggeratedly indicated for better understanding and ease of description, and this disclosure is not necessarily limited to as shown.

In the drawings, the thickness of layers, films, panels, regions, etc., are exaggerated for clarity. Furthermore, the thicknesses of parts of layers, films, regions, etc., are exaggerated for clarity. It will be understood that when an element such as a layer, film, region, or substrate is referred to as being “on” another element, it may be directly on the other element or intervening elements may also be present. In contrast, when an element is referred to as being “directly on” another element, there are no intervening elements present.

One embodiment provides an organic/inorganic hybrid membrane for fouling resistance including a composite of a hydrophilic inorganic particle and a quaternary ammonium compound dispersed in an organic polymer matrix.

As mentioned above, the hybrid membrane having antibiotic capability has been prepared mainly by using a membrane surface coating technology and an antibiotic material such as silver nanoparticles, titanium oxide, or the like. However, the membrane surface coating technology has a problem of peeling off, coating instability on the surface, and the like.

Accordingly, the embodiment of the present invention provides an organic/inorganic hybrid membrane overcoming a conventional problem on the surface of a coating layer and accomplishing increased water permeability and improved fouling resistance as well as antibiotic properties by compositing an antibiotic material inside a polymer membrane.

The organic/inorganic hybrid membrane includes an organic polymer matrix and a composite of hydrophilic inorganic particles and a quaternary ammonium compound dispersed in the organic polymer matrix, and may be prepared in-situ by a non-solvent induced phase-separation method that is generally used for preparation of a separation membrane for water treatment.

Specifically, an organic/inorganic hybrid membrane for fouling resistance including a composite of hydrophilic inorganic particles and a quaternary ammonium compound dispersed in an organic polymer matrix may be prepared by mixing hydrophilic inorganic particles or a precursor thereof with a quaternary ammonium compound in an organic polymer solution forming an organic polymer matrix, coating the mixture on a substrate, and then applying a non-solvent induced phase-separation method thereto.

The “non-solvent induced phase-separation method (NIPS)” using phase-separation of a polymer solution is known as a commercially available method of preparing a membrane such as a separation membrane for water treatment and the like from an organic polymer. The “non-solvent induced phase-separation method” is a method of preparing a polymer matrix through phase separation of a polymer solution by mixing a polymer with a polar organic solvent corresponding to a good solvent to prepare the polymer solution, coating the polymer solution on a substrate, and dipping the coated substrate in water as a non-solvent.

Accordingly, an organic polymer used to manufacture the organic/inorganic hybrid membrane may include any material formed into a polymer matrix according to the non-solvent induced phase-separation method, and may be selected from, for example, polysulfone, sulfonated polysulfone, polyethersulfone, polyphenylsulfone, sulfonated polyphenylsulfone, polyetherethersulfone, polyetherketone, polyetheretherketone, polyphenylene ether, polydiphenylphenylene ether, polyphenylene sulfide, cellulose acetate, cellulose diacetate, cellulose triacetate, polyacrylonitrile, or any mixture of two or more thereof.

In an example embodiment, the organic polymer may include an anionic functional group that is capable of binding with the quaternary ammonium compound by an electrostatic attractive force.

The “anionic functional group” indicates a functional group capable of providing a basic material with a proton, thus being present as an anion. For example, the anionic functional group may be an acidic functional group. The acidic functional group produces a hydronium ion (H₃O⁺) in an aqueous solution by using water molecules of a solvent as a base, and is present as an anion. However, when the anionic functional group coexists with a positively-charged material not even in a state of an aqueous solution, the positively-charged material takes a proton from the anionic functional group and thus is positively charged, while the anionic functional group may be present as an anion.

On the other hand, the quaternary ammonium compound, as described later, may be coated on the surface of an inorganic nanoparticle and prepared into an inorganic particle/quaternary ammonium compound having a core-shell structure. Herein, the core-shell type inorganic particle/quaternary ammonium compound may be positively-charged due to the ammonium ion, and when the positively-charged material meets an organic polymer material including the anionic functional group, these two materials may be bonded by an electrostatic attractive force therebetween. Accordingly, the electrostatic attractive force between the anionic functional group and the positively-charged material may not cause coagulation but allows uniform dispersal of the composite of an inorganic nanoparticle and a quaternary ammonium compound into the organic polymer solution. The anionic functional group may be a carboxyl group (—COOH), a sulfonic acid group (—SO₃H), a phosphinic group (—PO₃H₂), a phosphonic group (—HPO₃H), or a nitrous acid group (—NO₂H), but is not limited thereto. Therefore, the organic polymer may be a polymer substituted with the anionic functional group.

The hydrophilic inorganic particle may be selected from an oxide or a hydroxide of Ti, Al, Zr, Si, Sn, B, Ce, or a mixture thereof, and for example, may be selected from titania (TiO₂), silica (SiO₂), or a mixture thereof.

The inorganic nanoparticle may have a diameter of less than or equal to about 100 nm, for example, less than or equal to about 70 nm, about 5 nm to about 50 nm, or about 15 nm to about 30 nm.

The quaternary ammonium compound may be represented by the following Chemical Formula 1.

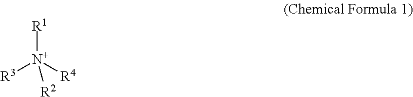

In the above Chemical Formula 1, R¹ to R³ are the same or different and are independently a C1 to C20 linear or branched alkyl group, R⁴ is —(CH₂)ₙ—SiR′, wherein R′ is a hydroxy group or a C1 to C6 alkoxy group, and n is an integer ranging from 1 to 10.

The quaternary ammonium compound represented by the above Chemical Formula 1 is known as an antibiotic material. The quaternary ammonium compound has antibiotic capability, since the positive charges thereof interact with the cell membrane of a microorganism such as bacteria and the like, and thus cause instability of materials on the surface of the cell membrane, transformation of the cell membrane, and resultantly necrosis of a cell.

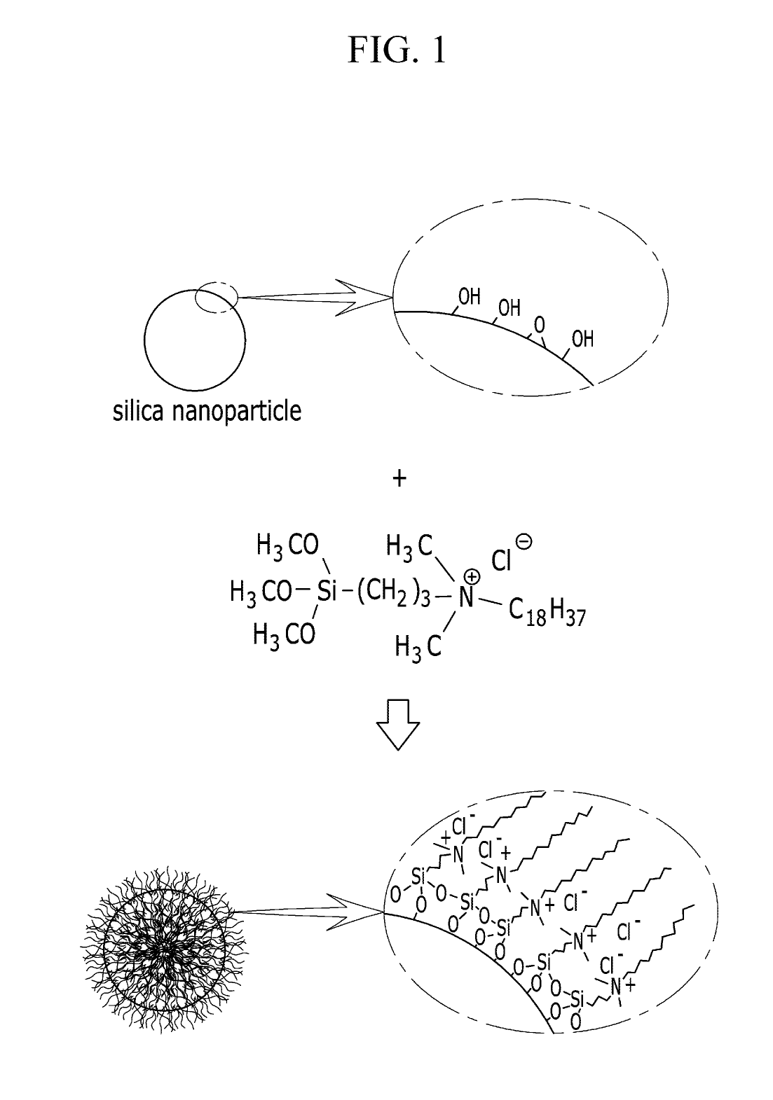

The composite of the hydrophilic inorganic particle and the quaternary ammonium compound may form a core-shell structure including a core of the inorganic particle and a shell of the quaternary ammonium compound by binding the quaternary ammonium compound with the surface of the hydrophilic inorganic particle. This will be schematically shown in FIG. 1.

Referring to FIG. 1, the core-shell structure of the composite formed by bonding the quaternary ammonium compound on the surface of the silica nanoparticle is schematically illustrated.

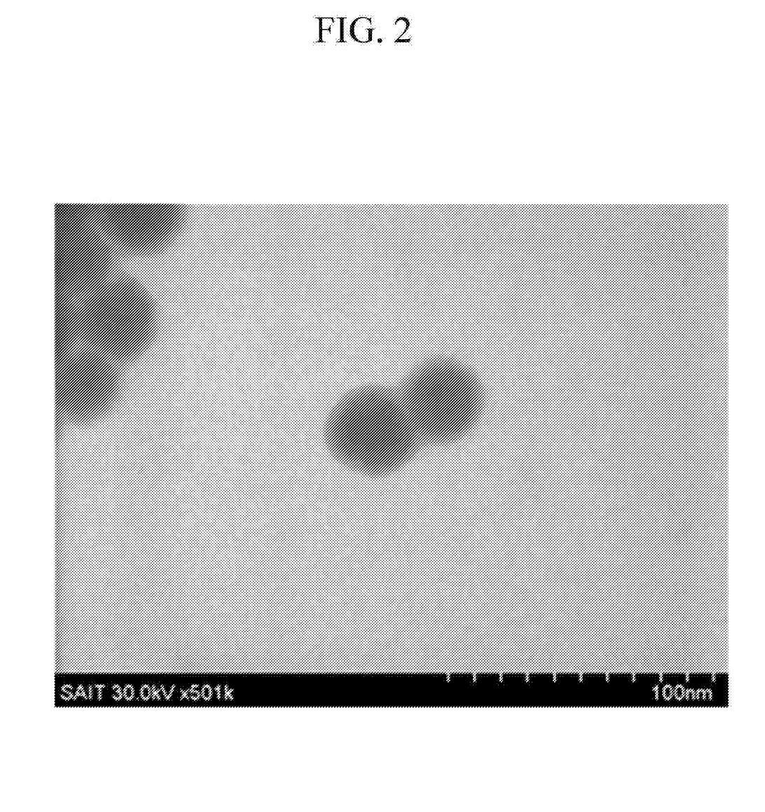

This inorganic nanoparticle-quaternary ammonium compound composite may be prepared by coating the surface of the inorganic nanoparticle with the quaternary ammonium compound before mixing the inorganic nanoparticle and the quaternary ammonium compound in a solution including an organic polymer. Specifically, the coating may be performed by mixing and agitating the inorganic nanoparticle and the quaternary ammonium compound in a solvent. This inorganic nanoparticle-quaternary ammonium compound composite may be isolated and washed, and may be mixed with the organic polymer solution to form an organic/inorganic hybrid membrane for fouling resistance. FIG. 2 is a scanning transmission electron microscope (STEM) photograph showing the silica nanoparticle-quaternary ammonium compound composite prepared in Example 1.

The composite of a hydrophilic inorganic particle and a quaternary ammonium compound may be prepared in situ by mixing the precursor of the inorganic nanoparticle with the quaternary ammonium compound in a solution including an organic polymer material, coating the mixture on a substrate, and applying a non-solvent induced phase-separation method thereto.

The precursor of the inorganic particle may be an alkoxide, an ester, an acetylacetonate, a halide, or a nitride of a Ti, Al, Zr, Si, Sn, B, or Ce element. This precursor of the inorganic nanoparticle contacts with water and is hydrolyzed, and thus may form a composite of the inorganic nanoparticle-quaternary ammonium compound in situ by applying the non-solvent induced phase-separation method after introducing the precursor along with the quaternary ammonium compound into the organic polymer solution.

The organic/inorganic hybrid membrane may have a finger-like pore structure.

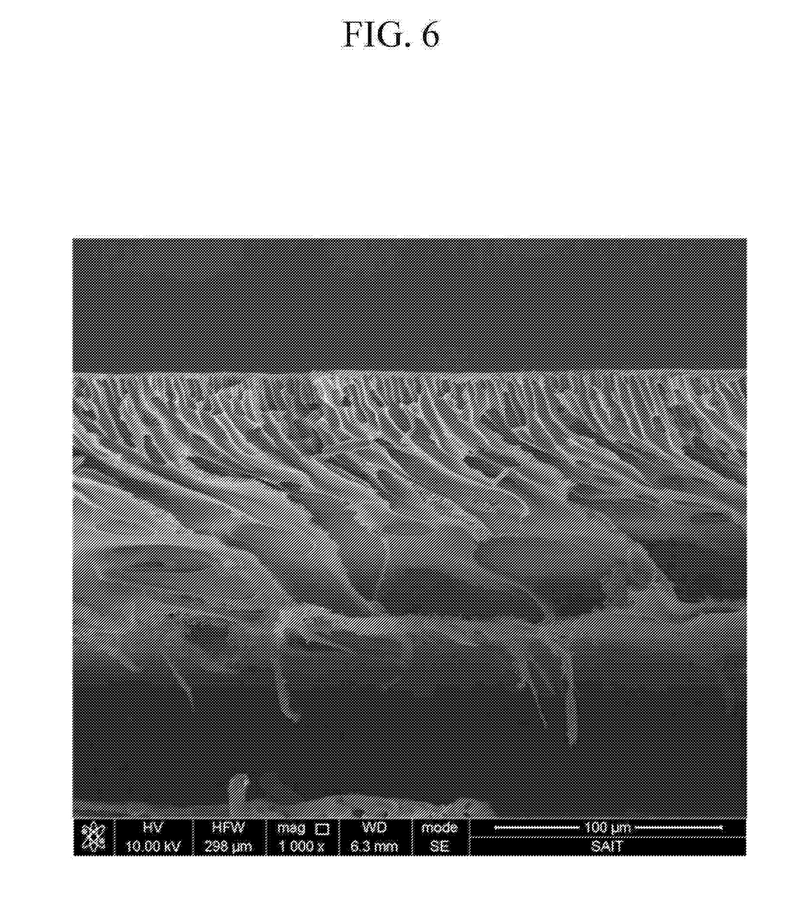

FIG. 6 is a scanning electron microscope (SEM) photograph showing the cross-section of the membrane prepared by mixing TEOS (tetraethyl orthosilicate) as a silica (SiO₂) precursor and a quaternary ammonium salt (3-(trimethoxysilyl)-propyldimethyloctadecyl ammonium chloride) in a polysulfone solution and using a non-solvent induced phase-separation method. Referring to FIG. 6, the membrane has finger-like pores.

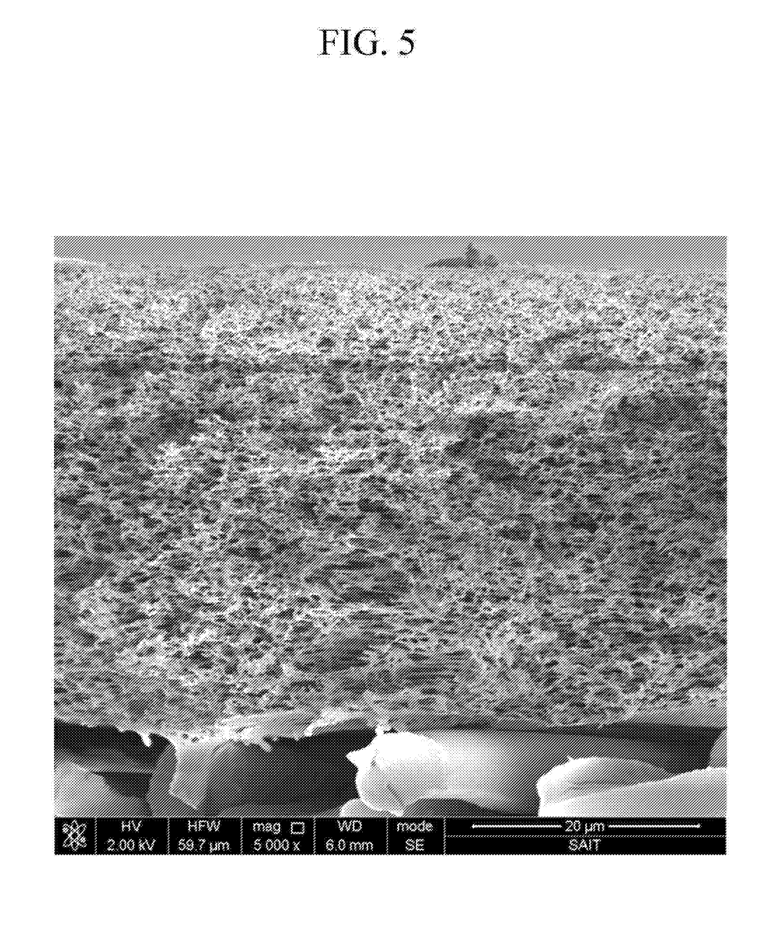

On the other hand, FIG. 5 is a SEM photograph showing that a membrane prepared by using only a polysulfone solution including neither the inorganic particle nor the quaternary ammonium salt and applying the non-solvent induced phase-separation method does not have finger-like pores but rather has a sponge-type cross-section.

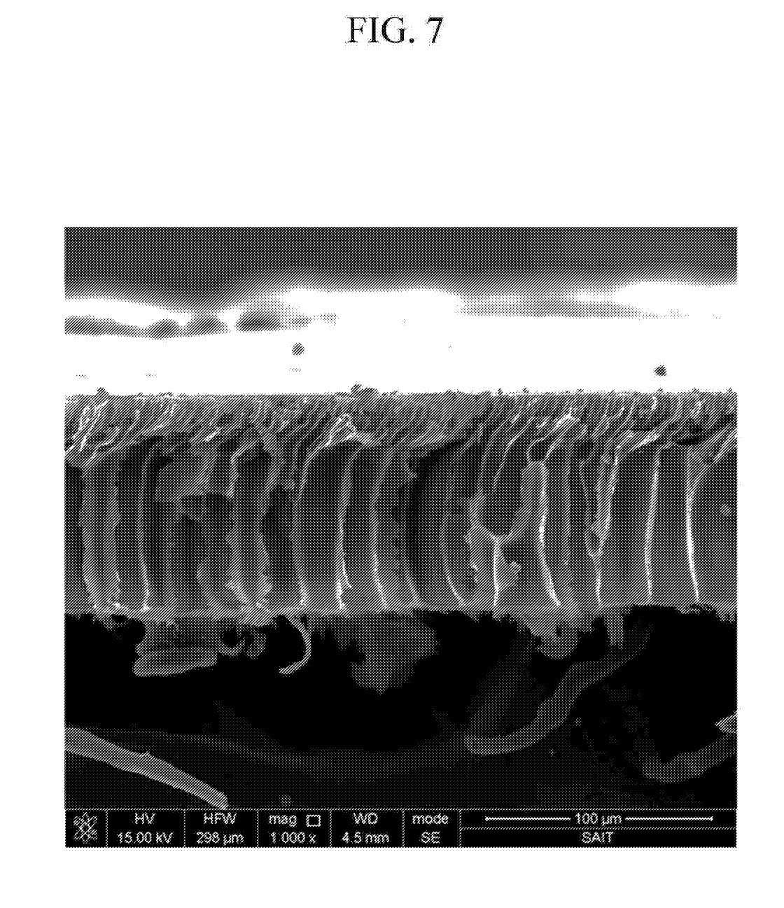

FIG. 7 is a SEM photograph showing the cross-section of a membrane prepared by using TTIP of a titania (TiO₂) precursor as the inorganic particle and the quaternary ammonium salt in the polysulfone polymer solution, and applying the non-solvent induced phase-separation method. Referring to FIG. 7, the same finger-like pore structure as shown in FIG. 6 is found.

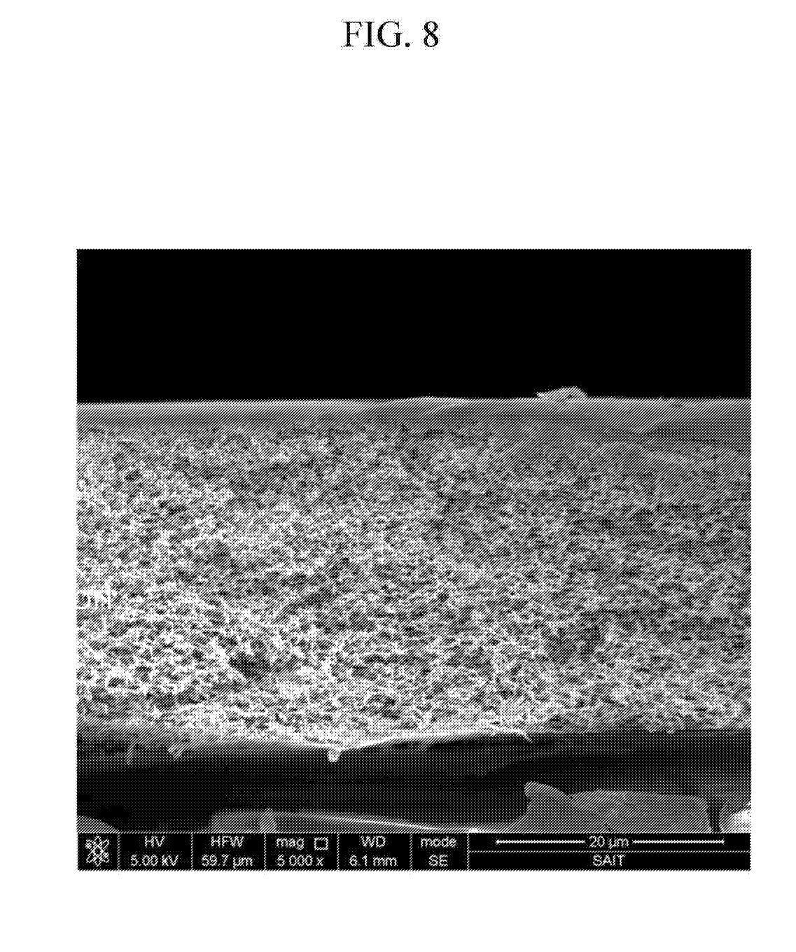

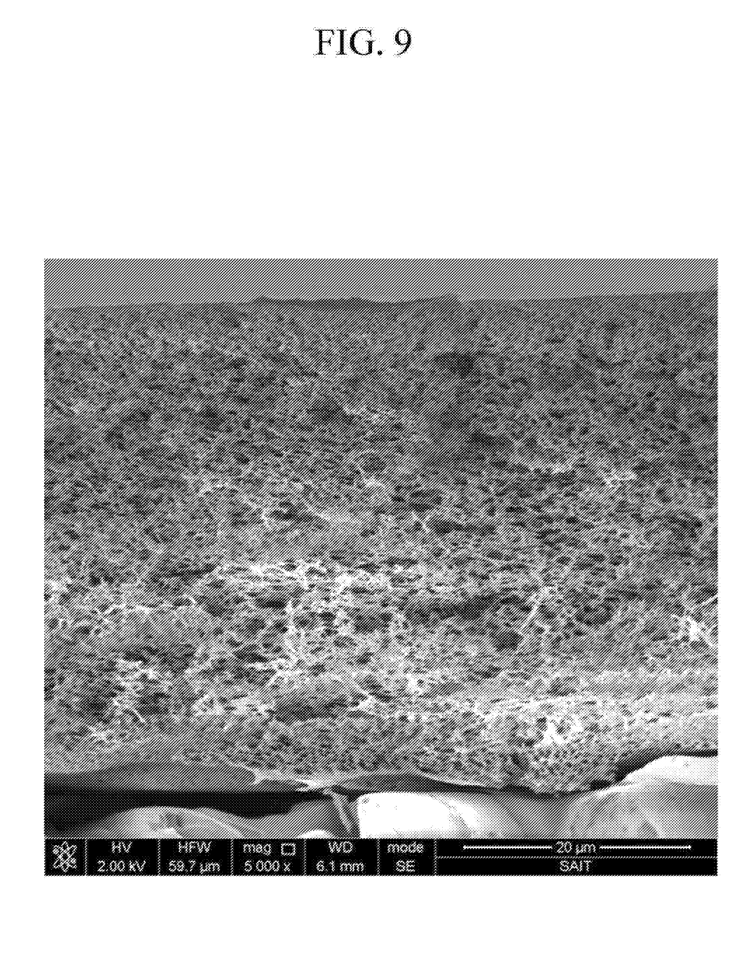

In order to determine if the finger-like pore structure is formed by the hydrophilic inorganic particle or the quaternary ammonium compound, FIGS. 8 and 9 respectively provide SEM photographs showing the cross-section of each membrane prepared by adding only TEOS or TTIP as a hydrophilic inorganic particle precursor to a polysulfone polymer solution and using a non-solvent induced phase-separation method.

Neither of FIG. 8 or 9 show the same finger-like pore structure as in FIG. 6 or 7, but have a sponge-type structure as shown in the cross-section of a membrane formed of only polysulfone.

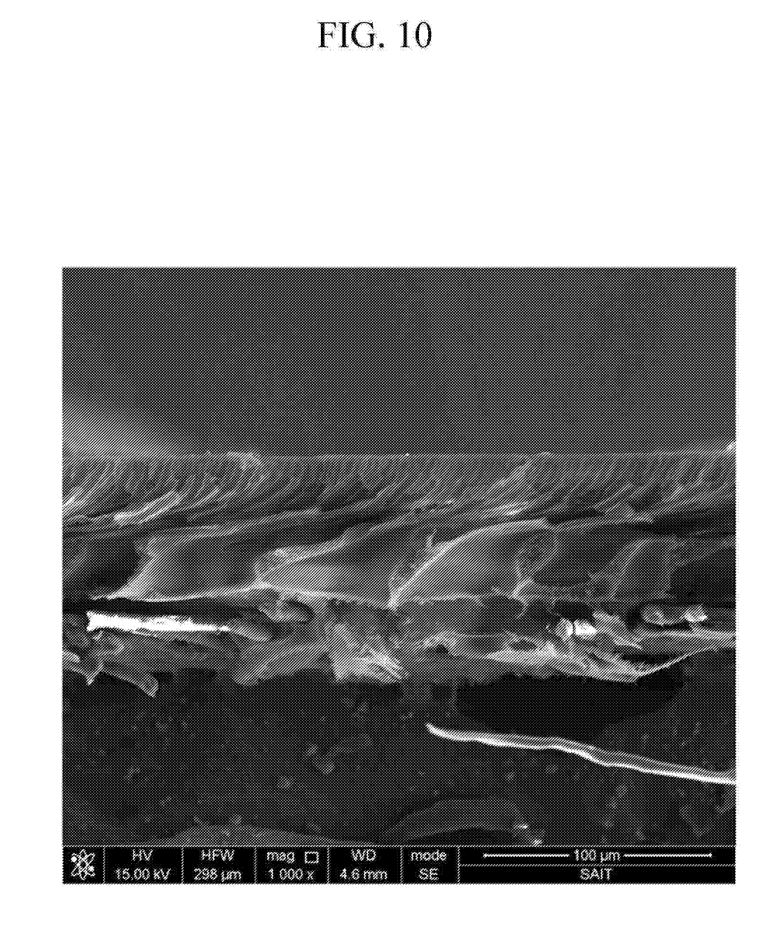

FIG. 10 is a SEM photograph showing the cross-section of a membrane prepared by adding only the quaternary ammonium compound to polysulfone and using a non-solvent induced phase-separation method.

FIG. 10 shows a similar finger-like pore structure to those of FIGS. 6 and 7.

In other words, the finger-like pore structure of a membrane including a composite of a hydrophilic inorganic particle and a quaternary ammonium compound according to the embodiment is formed due to addition of the quaternary ammonium compound, and accordingly, the quaternary ammonium compound may form the finger-like pore structure and thus increase water flux of the membrane as well as provide the membrane with antibiotic properties. Accordingly, the organic/inorganic hybrid membrane for fouling resistance according to the embodiment may increase fouling resistance and water flux as shown in the post-described examples.

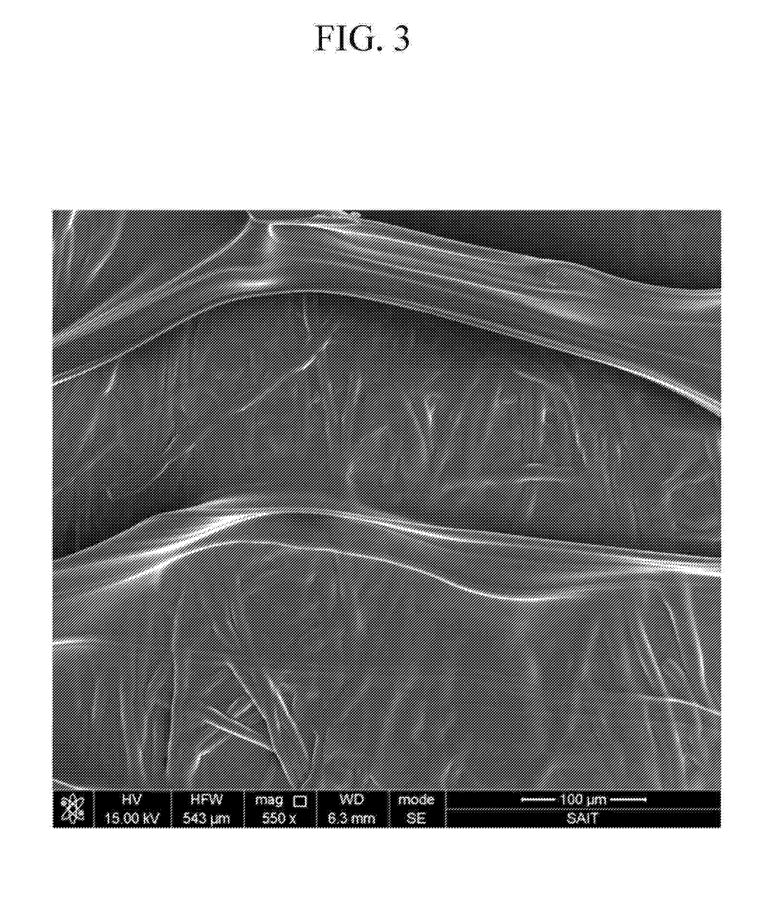

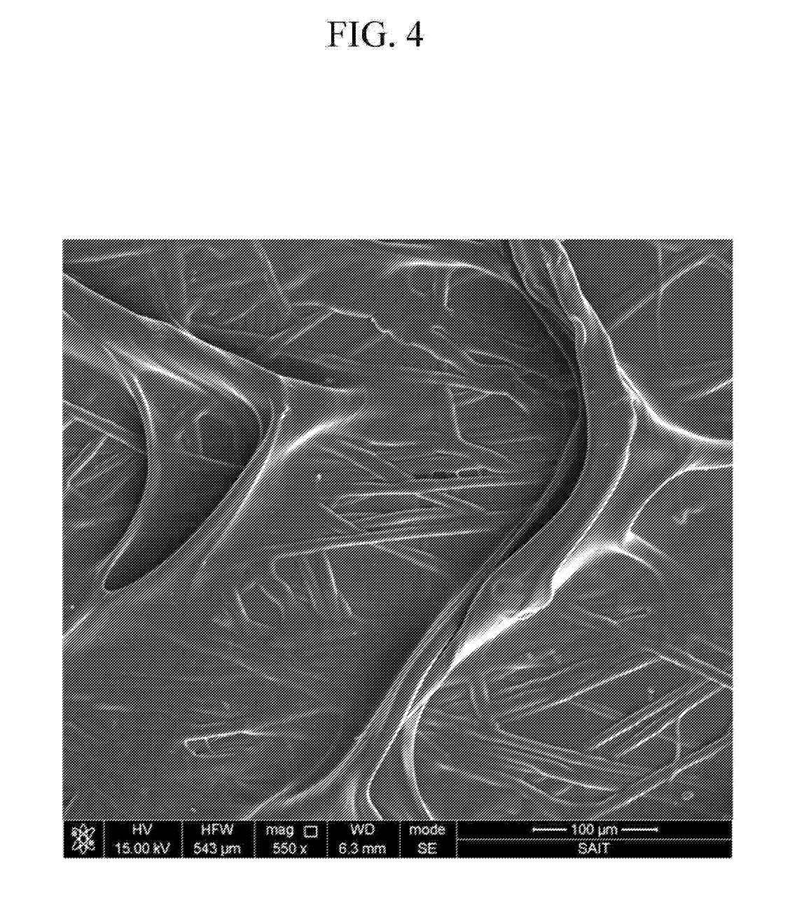

On other hand, FIG. 3 is a SEM photograph showing a membrane prepared by using a sulfonated polyphenylsulfone solution having an anionic functional group. In addition, FIG. 4 is a SEM photograph showing a membrane prepared by introducing the silica nanoparticle-quaternary ammonium compound composite of Example 1 into the sulfonated polyphenylsulfone solution.

In both the photographs, a finger-like structure is not found. Since polyphenylsulfone, unlike polysulfone, forms no finger-like structure, the finger-like structure is not formed even by adding a silica nanoparticle-quaternary ammonium compound composite.

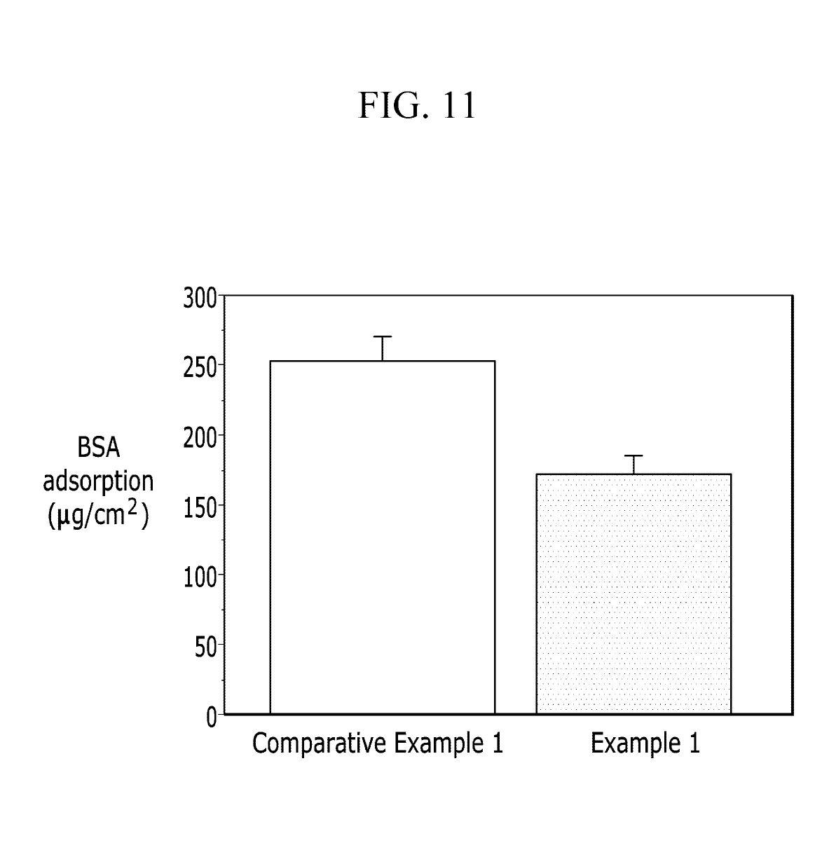

As shown in FIG. 11, the membrane according to Example 1 does not include a finger-like structure but shows improved surface fouling resistance against BSA (bovine serum albumin) compared with the sulfonated polyphenylsulfone membrane not treated with the silica nanoparticle-quaternary ammonium compound composite according to Comparative Example 1. In other words, the finger-like structure relates to water permeability of a membrane but not to fouling resistance of the membrane.

In another embodiment, a method of preparing an organic/inorganic hybrid membrane for fouling resistance that includes preparing an inorganic nanoparticle or a precursor of the inorganic nanoparticle, and a quaternary ammonium compound, adding the prepared inorganic nanoparticle or precursor of the inorganic nanoparticle and quaternary ammonium compound in an organic polymer solution to prepare a mixture, and applying a non-solvent induced phase-separation method after casting the mixture on a substrate.

The hydrophilic inorganic particle, quaternary ammonium compound, and organic polymer material may be the same as described above, and thus detailed descriptions thereof are not provided.

The process of preparing the inorganic nanoparticle or the precursor of the inorganic nanoparticle and the quaternary ammonium compound may include forming a composite of an inorganic nanoparticle-quaternary ammonium compound by coating the surface of the inorganic nanoparticle with the quaternary ammonium compound.

As aforementioned, the composite of an inorganic nanoparticle and a quaternary ammonium compound may be obtained by contacting the inorganic nanoparticle and the quaternary ammonium compound in a solvent as a method of preparing the composite of the inorganic nanoparticle and the quaternary ammonium compound before mixing the inorganic nanoparticle and the quaternary ammonium compound in an organic polymer solution. Specifically, the inorganic nanoparticle and the quaternary ammonium compound are mixed and dispersed in a solvent, obtaining an inorganic nanoparticle-quaternary ammonium compound composite in which the quaternary ammonium compound is coated on the surface of the inorganic nanoparticle.

For example, the inorganic nanoparticle-quaternary ammonium compound composite may be obtained by dispersing a silica nanoparticle into a mixed solvent of water and ethanol, adding the quaternary ammonium compound thereto, and agitating the mixture so that the quaternary ammonium compound may be coated on the surface of the silica nanoparticle. This obtained silica nanoparticle-quaternary ammonium compound composite may be added to the organic polymer solution after being prepared and washed.

As aforementioned, since the inorganic nanoparticle-quaternary ammonium compound composite is positively charged due to the ammonium ions, an organic polymer having an anionic functional group may be used. For example, the organic polymer including an anionic functional group may be sulfonated polyphenylsulfone. The inorganic nanoparticle-quaternary ammonium compound composite and the organic polymer having an anionic functional group may be stably bonded due to an electrostatic attractive force therebetween, and accordingly, the inorganic nanoparticle-quaternary ammonium compound composite may not be dispersed into water of a non-solvent but may remain in a polymer solution even when a non-solvent induced phase-separation method is applied.

Alternatively, the process of preparing the precursor of the inorganic nanoparticle or the inorganic nanoparticle and the quaternary ammonium compound may include preparation of the precursor of the inorganic nanoparticle and the quaternary ammonium compound. In this process, a material being transformed into an inorganic particle, that is, the precursor of the inorganic particle and the quaternary ammonium compound are prepared, and then mixed in an organic polymer solution. Both the precursor of the inorganic nanoparticle and the quaternary ammonium compound may be present to be well mixed with an organic polymer, and thus the organic polymer does not necessarily include an anionic functional group. Herein, the organic polymer may include polysulfone, but is not limited thereto.

The precursor of the inorganic nanoparticle may be an alkoxide, an ester, an acetylacetonate, a halide, or a nitride of a Ti, Al, Zr, Si, Sn, B, or Ce element, and for example, a silica precursor may be TEOS (tetraethyl orthosilicate), TMOS (tetramethyl orthosilicate), and the like, but is not limited thereto. The precursor of an inorganic particle contact water and is hydrolyzed when a non-solvent induced phase-separation method is applied thereto, and thus may be transformed into an inorganic nanoparticle forming a composite with the quaternary ammonium compound in situ.

Either of these two methods may provide an inorganic nanoparticle-quaternary ammonium compound composite including an inorganic nanoparticle core and a quaternary ammonium compound on the core, thus having a core-shell structure.

The inorganic nanoparticle-quaternary ammonium compound composite is uniformly dispersed in an organic polymer matrix, and may improve fouling resistance and water permeability of a membrane.

A solvent dissolving the organic polymer may include any solvent widely used in a related art. For example, the solvent may be one or more organic solvents selected from acetone; acids such as acetic acid, trifluoroacetic acid (TFA), and the like; alcohols such as methanol, isopropanol, 1-methoxy-2-propanol, ethanol, terpineol, and the like; oxygen-containing cyclic compounds such as tetrahydrofuran (THF), 1,4-dioxane (THF), sulfolane, 1,4-dioxane, and the like; aromatic compounds including a heteroatom of N, O, or S such as pyridine and the like; halogen compounds such as chloroform, methylene chloride, and the like; aprotic polarity compounds such as dimethylformamide (DMF), dimethylacetamide (DMAC), dimethylsulfoxide (DMSO), N-methyl-2-pyrrolidone (NMP), and the like; and acetates such as 2-butoxyethylacetate, 2(2-butoxyethoxy)ethylacetate, and the like, but is not limited thereto.

When a polymer solution obtained by using the solvent is coated on a substrate, the solvent capable of applying a non-solvent induced phase-separation method to the polymer solution may generally be water.

In another embodiment, a separation membrane for water treatment including the organic/inorganic hybrid membrane for fouling resistance is provided.

The organic/inorganic hybrid membrane may be used as a support layer of a separation membrane for water treatment. Accordingly, the separation membrane for water treatment may further include an additional polymer matrix forming a separation layer that is water permeable but non-permeable for a subject material to be separated such as a salt, on one surface of the support layer.

The additional polymer matrix for forming the separation layer of the separation membrane for water treatment may include an aryl backbone polymer such as polyamide, polyethylene, polyester, polyisobutylene, polytetrafluoroethylene, polypropylene, polyacrylonitrile, polysulfone, polyethersulfone, polycarbonate, polyethylene terephthalate, polyimide, polyvinylene fluoride, polyvinylchloride, and the like, or cellulose acetate, cellulose diacetate, or cellulose triacetate, but is not limited thereto.

The separation membrane for water treatment may be prepared by polymerizing a separation layer consisting of the polymer matrix through interface polymerization, on one surface of the organic/inorganic hybrid membrane for fouling resistance. A polymerization method of the polymer matrix through interface polymerization is well-known in this art, and thus detailed descriptions thereof are not provided.

In another embodiment, a water treatment device including the separation membrane for water treatment is provided.

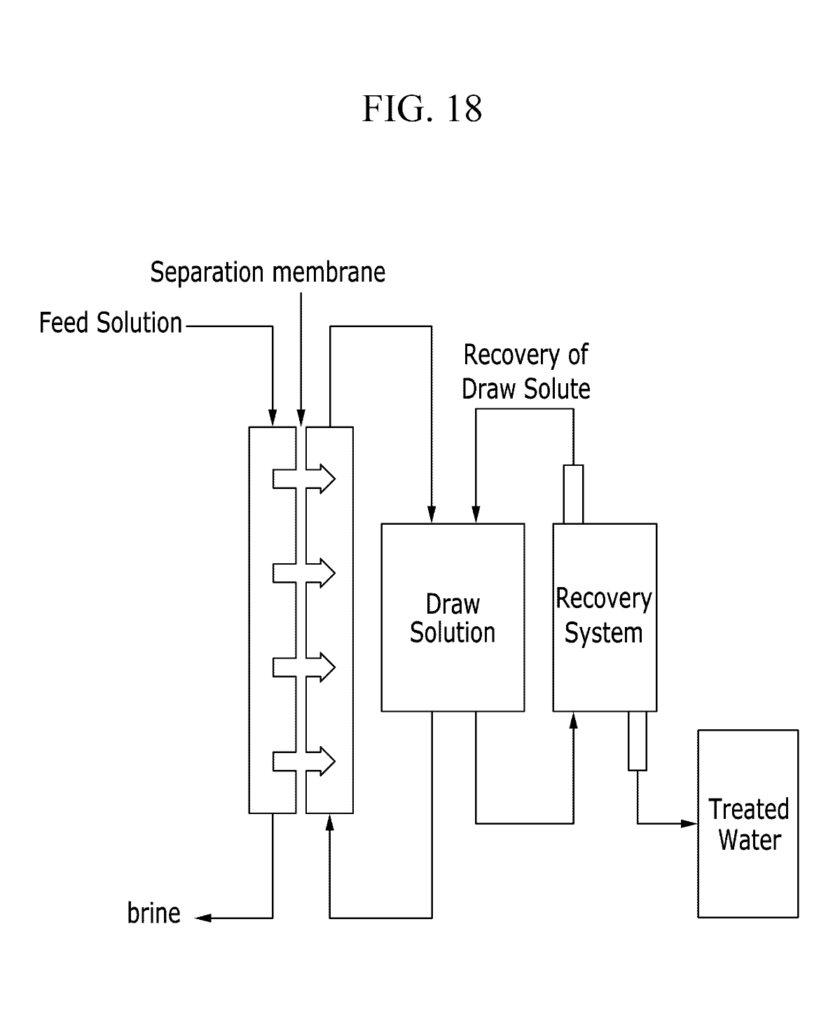

The water treatment device may be a forward osmosis water treatment device or a reverse osmosis water treatment device. FIG. 18 shows a forward osmosis water treatment device according to an example embodiment.

The forward osmosis water treatment device includes:

a first housing including a receiving part for a feed solution including a subject material to be separated, a receiving part for an osmosis draw solution having a higher osmotic pressure concentration than the feed solution, and a separation membrane disposed between the receiving part for a feed solution and the receiving part for an osmosis draw solution;

a second housing for storing the osmosis draw solution in order to supply the osmosis draw solution to the first housing and to recover the osmosis draw solution from the housing; and

a recovery unit for separating and recovering a solute of the osmosis draw solution.

The separation membrane includes an organic/inorganic hybrid membrane including a composite of an inorganic nanoparticle and a quaternary ammonium compound dispersed in an organic polymer matrix, as a support layer, and further includes a separation layer of an interface polymerized organic polymer matrix on one surface of the organic/inorganic hybrid membrane.

The forward osmosis water treatment device may further include a device discharging the resultant as treated water after separating the osmosis draw solute from the osmosis draw solution including water passing the separation membrane from the feed solution due to osmotic pressure through the recovery unit.

The forward osmosis water treatment device may have the same organic/inorganic hybrid membrane and active layer of the separation membrane as described above, and thus will not be described in detail.

The feed solution may include sea water, brackish water, wastewater, tap water to be treated for drinking, and the like.

The water treatment device may be applied for water purification, wastewater treatment and reuse, seawater desalination, and the like.

Hereinafter, the embodiments are illustrated in more detail with reference to examples. However, the following examples merely exemplify specific embodiments, but do not limit the present invention.

### MODE FOR INVENTION

### EXAMPLES

### Example 1

### Manufacture of Organic/Inorganic Hybrid Membrane Using Silica Nanoparticle

A core/shell structure of a silica/antibiotic material is prepared by treating the surface of a silica nanoparticle with quaternary ammonium silane. Specifically, 7.5 g of colloidal silica nanoparticles (22 nm) is agitated with a mixed solution of water and ethanol (1:1 wt %), and the agitated mixture is dispersed by using an ultrasonic wave disperser for about 20 minutes. 2 ml of 3-(trimethoxysilyl)-propyldimethyloctadecyl ammonium chloride is added to the dispersion solution in a dropwise fashion, and the mixture is agitated for one night to lead a core/shell reaction. The obtained silica/antibiotic material core/shell composite is separated through a centrifuge, and then washed with water and ethanol and dried in a vacuum oven for one day. FIG. 1 shows a formation process and a schematic shape of the core/shell-type silica nanoparticle-quaternary ammonium compound composite, and FIG. 2 shows a scanning transmission electron microscope (STEM) photograph of the composite particle.

An organic/inorganic composite polymer membrane is prepared by dissolving 13 g of sulfonated polyphenylsulfone (a substitution degree with a sulfone group: 50%, IEC: 2.08) in 50 ml of dimethylformamide (DMF) as an organic solvent. In addition, 0.5 g of the silica/antibiotic material composite is dispersed in 37 ml of another DMF solvent through ultrasonic wave dispersion. The solution prepared by dispersing the silica/antibiotic material composite is uniformly mixed, bubbles are removed therefrom, and then the inorganic/polymer composite solution is coated on a non-woven fabric. Then, a membrane is formed through a non-solvent phase transition method in which a polymer solution undergoes phase transition into a solid by dipping the coated substrate in water as a non-solvent against a polymer. Herein, the silica/antibiotic material composite in the membrane is uniformly dispersed into the sulfonated polyphenylsulfone polymer with the polymer and stably bonded therewith due to an electrostatic attractive force.

FIG. 4 provides a SEM photograph showing the organic/inorganic hybrid membrane.

### Comparative Example 1

### Manufacture of Sulfonated Polyphenylsulfone Membrane not including Silica/antibiotic Material Composite

A membrane according to Comparative Example 1 is prepared by using only sulfonated polyphenylsulfone but no silica/antibiotic material composite used in Example 1, and FIG. 3 shows a SEM photograph of the membrane. Herein, the membrane is also prepared in a non-solvent induced phase-separation method according to the same method as Example 1, except for using no silica/antibiotic material composite.

### Example 2

### Manufacture of Organic/Inorganic Hybrid Membrane using Silica Precursor

A membrane is prepared by mixing 1 ml of tetraethyl orthosilicate (TEOS) as a silica precursor and 2 ml of 3-(trimethoxysilyl)-propyldimethyloctadecyl ammonium chloride with a polysulfone polymer solution (13 wt %/DMF) to prepare a polymer membrane solution including a composite of an inorganic nanoparticle and an antibiotic material through an in situ process, and then coating the mixed solution on a non-woven fabric in the same non-solvent induced phase-separation method as Example 1. Referring to a SEM photograph of the membrane, a finger-like pore structure is found in the membrane (Refer to FIG. 6).

### Example 3

### Manufacture of Organic/Inorganic Hybrid Membrane using Titania Precursor

An organic/inorganic hybrid membrane is prepared according to the same method as Example 2, except for using titanium tetraisopropoxide (TTIP) as a hydrophilic inorganic precursor instead of the TEOS. In other words, a membrane is prepared by mixing 1 ml of TTIP and 2 ml of 3-(trimethoxysilyl)-propyldimethyloctadecyl ammonium chloride with a polysulfone polymer solution (13 wt %/DMF), and coating the solution on a non-woven fabric by using a non-solvent induced phase-separation method as in Example 1. Referring to a SEM photograph of the membrane, a finger-like pore structure is found in the membrane (refer to FIG. 7).

### Comparative Example 2

### Manufacture of Polysulfone Membrane

A membrane is prepared by using only polysulfone but neither of a hydrophilic inorganic precursor nor quaternary ammonium salt as an antibiotic material. In other words, the membrane is prepared by coating a polysulfone polymer solution (13 wt %/DMF) on a non-woven fabric through a non-solvent induced phase-separation method. Referring to a SEM photograph of the membrane, the cross-section of the membrane has a sponge structure (refer to FIG. 5).

### Comparative Example 3

### Membrane including Silica Precursor

A membrane is prepared by mixing 1 ml of tetraethyl orthosilicate (TEOS) as a silica precursor with a polysulfone polymer solution (13 wt %/DMF) and coating the solution on a non-woven fabric by using a non-solvent induced phase-separation method as in Example 1. Referring to a SEM photograph of the membrane, the membrane has a cross-section of a sponge structure (refer to FIG. 8).

### Comparative Example 4

### Membrane including Titania Precursor

A membrane is prepared by mixing 1 ml of TTIP as a titania precursor with a polysulfone polymer solution (13 wt %/DMF), and coating the solution on a non-woven fabric by using a non-solvent induced phase-separation method as in Example 1. Referring to a SEM photograph of the membrane, the membrane has a cross-section of a sponge structure (refer to FIG. 9).

### Comparative Example 5

### Membrane including Quaternary Ammonium Compound

A membrane including no hydrophilic inorganic nanoparticle but only a quaternary ammonium compound is prepared. In other words, the membrane is prepared by mixing 2 ml of 3-(trimethoxysilyl)-propyldimethyloctadecyl ammonium chloride with a polysulfone polymer solution (13 wt %/DMF), and coating the solution on a non-woven fabric by using a non-solvent induced phase-separation method as in Example 1. Referring to a SEM photograph of the membrane, a finger-like pore structure is formed in the membrane (refer to FIG. 10).

### Experimental Example 1

### Fouling Resistance of Membrane

In order to evaluate fouling resistance of the organic/inorganic hybrid membranes, the membrane according to Example 1 and the membrane treated with neither the hydrophilic inorganic nanoparticle nor the quaternary ammonium compound according to Comparative Example 1 are respectively contacted with a BSA (bovine serum albumin) protein solution (1 g/I) to absorb a fouling material for a given or predetermined time (12 to 14 hours). After the given or predetermined time, the membrane is separated from the solution, and the BSA lightly attached to the surface of the membrane is washed off and dipped in the initial BSA solution. The concentration of the BSA remaining in the solution is measured through TOC (total organic carbon) or UV to calculate the concentration of the BSA adsorbed in the surface of the membrane, and the results are provided in a graph (refer to FIG. 11). As a result, adsorption of the BSA on the surface of the membrane including the composite of a silica nanoparticle and a quaternary ammonium compound according to Example 1 remarkably decreased.

### Experimental Example 2

### Evaluation of Water Flux and Fouling Resistance

A dead-end cell fouling test is performed by applying a 1 g/L BSA solution with one bar of pressure to each membrane according to Examples 2 and 3 and Comparative Examples 2, 3, and 5, and the results are provided in the following Table 1.

The dead-end cell fouling test is specifically performed by filling pure distilled water in a dead-end cell, passing the distilled water through the membrane by applying a pressure with one 1 bar, and then measuring the amount of the passed water to measure a pure water flux (P0). Then, the amount of a liquid passing the membrane (P1) is measured by filling a 1 g/L BSA solution in a dead-end cell and applying a pressure in the same method as above, and then the amount of distilled water passing the membrane (P2) is measured by washing the membrane with distilled water after the former measurement and filling the dead-end cell with distilled water again. As a result, relative flux recovery, reversible fouling, and irreversible fouling may be expressed in the following formula, and the results are provided in the following Table 1.

Relative flux recovery (%)=P2/P0*100

Reversible fouling (%)=(P2-P1)/P0*100

Irreversible fouling (%)=(1-P2/P0)*100

TABLE 1

| | Comp. | Comp. | Comp. | | |
|---|---|---|---|---|---|
| | Ex. 2 | Ex. 3 | Ex. 5 | Ex. 2 | Ex. 3 |
| Pure water flux (LMH) | 2848 | 2959 | 4137 | 3656 | 4212 |
| Relative flux recovery | 22.9 | 22.7 | 27.9 | 32.0 | 33.0 |
| (%) | | | | | |
| Reversible fouling (%) | 22.4 | 22.2 | 27.40 | 31.6 | 32.7 |
| Irreversible fouling (%) | 77.2 | 77.3 | 72.0 | 68.0 | 67.0 |

Referring to the results, the test results using the membranes according to Example 2 or 3 show an increased relative flux recovery and reversible fouling but decreased irreversible fouling compared with the test result using the membrane including neither an inorganic nanoparticle nor an antibiotic material composite according to Comparative Example 2 and the membranes not including either of an inorganic nanoparticle or an antibiotic material according to Comparative Examples 3 and 5. In other words, the membranes according to Examples 2 and 3 show improved fouling resistance and water permeability.

### Experimental Example 3

### Manufacture of Hybrid Membrane and Evaluation of Forward Osmosis Performance

The forward osmosis performance of separation membranes respectively including the membranes according to Comparative Example 2 and Examples 2 and 3 as a support layer is evaluated.

First, a forward osmosis separation membrane (polyamide) is formed on each membrane (the membranes obtained from Comparative Examples 2 and Examples 2 and 3) as a support layer by dipping each membrane in a 3.4 wt % m-methylenediamine (MPD) solution for 2 minutes, so that the methylenediamine solution might be uniformly permeated into each organic/inorganic hybrid membrane. Then, the membrane is taken out of the solution, an MPD aqueous solution is removed from the surface of the membrane with a rubber roller, and an organic solution (e.g., Isopar G) including 0.15 wt % of trimesoylchloride (TMC) is contacted with the surface of the membrane for about 1 minute to induce interface polymerization to form a polyamide layer. Subsequently, when the polymerization is complete, the membrane is obtained by draining a remaining non-reaction solution, washed through an n-hexane solution and dried, and then washed again in flowing water.

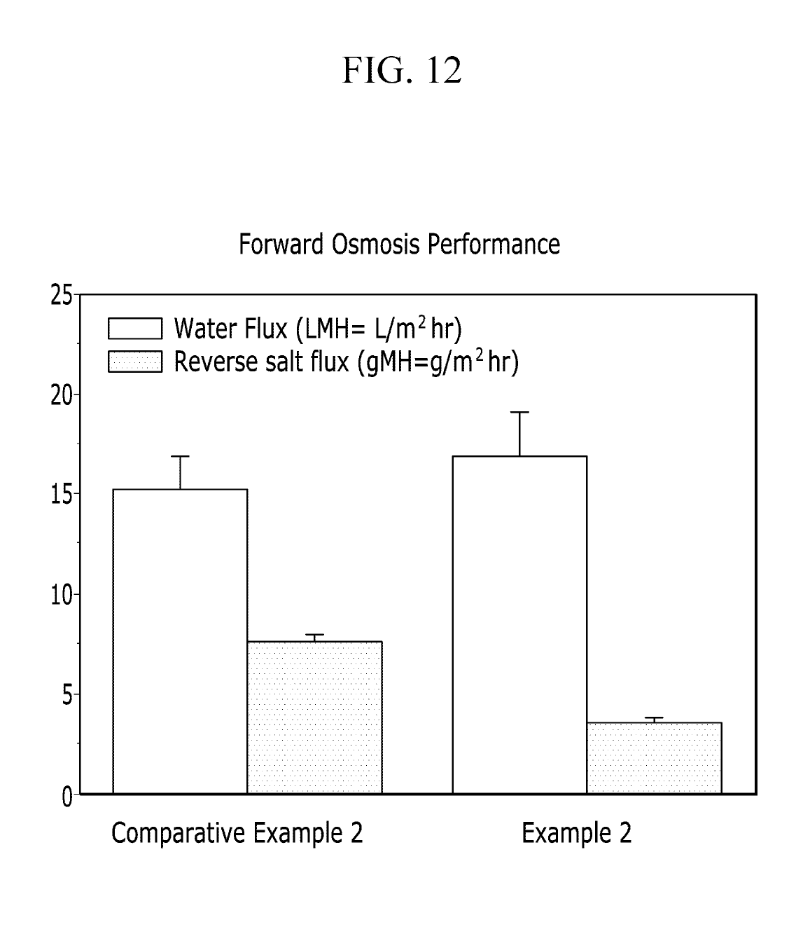

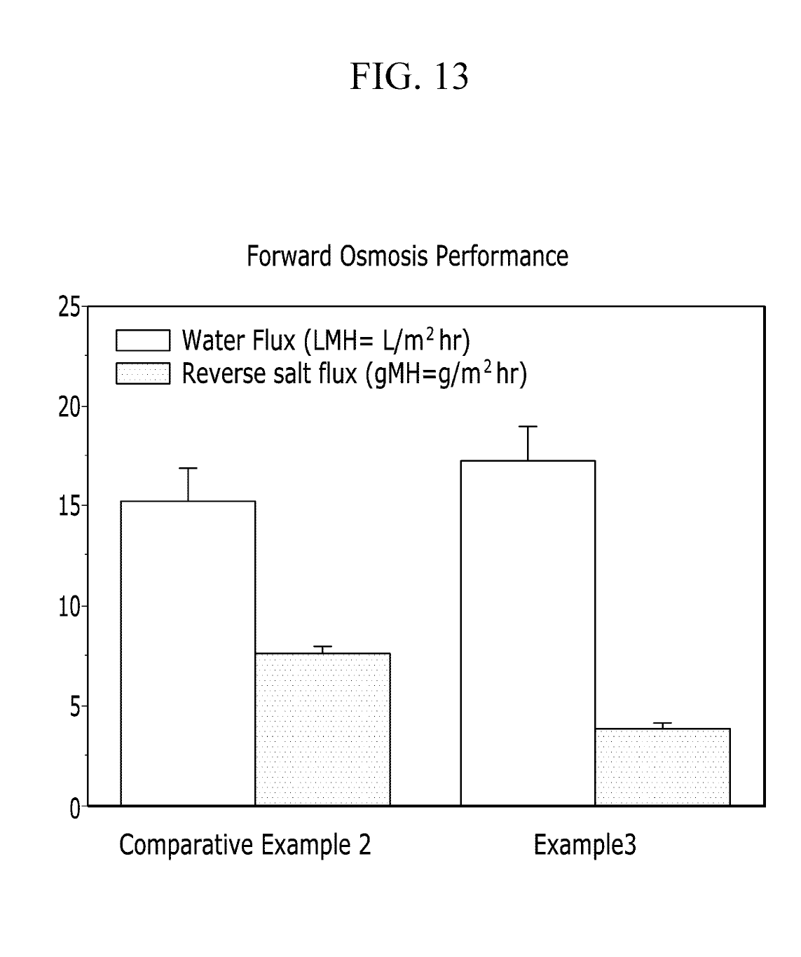

Each hybrid membrane including the polyamide separation layer and the support layer is mounted in a forward osmosis cell with the polyamide separation layer being in contact with a feed solution. The water fluxes and reverse salt fluxes are calculated by using distilled water as a feed solution and a 1.0 M NaCl solution as a draw solution and measuring the weight of water passing from the feed solution to the draw solution as well as the weight of a salt passing from the draw solution to the feed solution through measurement of conductivity, while the feed and draw solutions are simultaneously let to cross-flow on the surface of the membrane at 20° C. at a speed of 10.7 cm/sec, and the results are provided in FIGS. 12 and 13. FIG. 12 shows the results of the separation membranes respectively using the support layers of Comparative Example 2 and Example 2, and FIG. 13 shows the results of the separation membranes respectively using the support layers of Comparative Example 2 and Example 3.

As shown from FIGS. 12 and 13, the separation membranes including the support layers obtained by introducing a composite of an inorganic nanoparticle and a quaternary ammonium compound according to Examples 2 and 3 show an increased forward osmosis water flux but a decreased reverse salt flux. In other words, a separation membrane including an organic/inorganic hybrid membrane for fouling resistance according to one embodiment of the present invention as a support layer includes a hydrophilic inorganic nanoparticle and an antibiotic material inside the membrane, and solves a problem of a conventional membrane coated with these materials on the surface, and furthermore, changes the pore structure of a polymer matrix by introducing the antibiotic material thereinto and thus shows much increased water permeability and improved fouling resistance. Therefore, the organic/inorganic hybrid membrane for fouling resistance may be applied to a separation membrane for water treatment and the like.

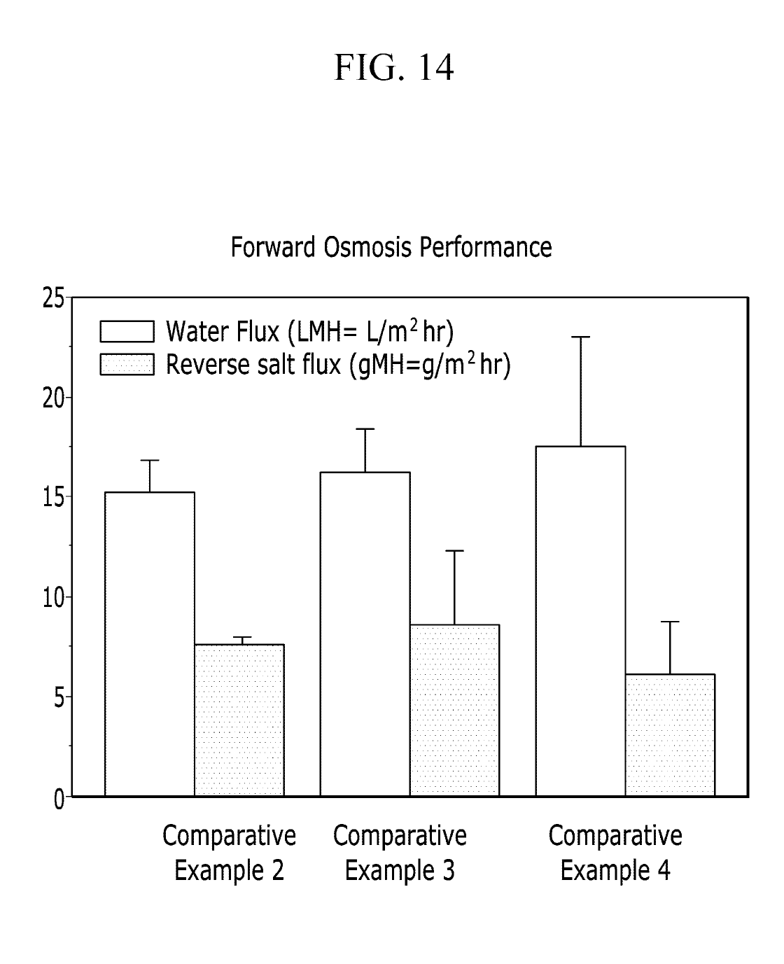

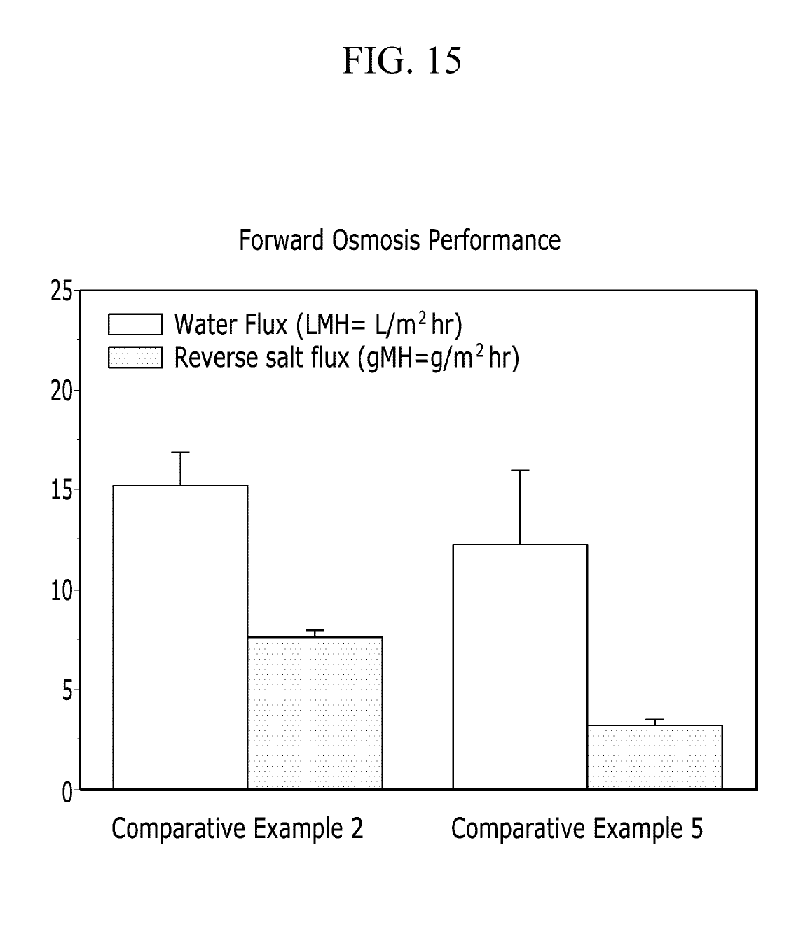

On the other hand, forward osmosis water fluxes and reverse salt fluxes of the separation membranes respectively including the membranes according to Comparative Examples 3 to 5 as a support layer and forming a polyamide separation layer thereon are measured in the same method as aforementioned, and the results are provided in FIGS. 14 and 15.

As shown from FIG. 14, the separation membrane obtained by introducing a precursor of silica (Comparative Example 3) or titania (Comparative Example 4) as an inorganic nanoparticle into polysulfone shows a much higher forward osmosis water flux due to a hydrophilic property of the nanoparticle than the separation membrane including a single polysulfone support layer (Comparative Example 2). However, the separation membrane of Comparative Example 4 shows a higher reverse salt flux that is proportional to the forward osmosis water flux than the separation membrane of Comparative Example 2. On the other hand, the separation membrane of Comparative Example 3 shows a higher forward osmosis water flux but a lower reverse salt flux than the separation membrane of Comparative Example 2 or 4, which shows that a membrane including a precursor of a silica nanoparticle in polysulfone shows better forward osmosis water flux and lower reverse salt flux than a membrane that does not include silica nanoparticles, provided that that the membranes do not include a quaternary ammonium compound.

FIG. 15 shows that a separation membrane including the support layer of Comparative Example 5 (a membrane prepared by including a quaternary ammonium compound in polysulfone) shows lower forward osmosis water flux but lower reverse salt flux that is proportionate to the forward osmosis water flux than the separation membrane including a single polysulfone membrane according to Comparative Example 2 as a support layer. Based on the result of FIG. 15, a finger-like structure is formed by introducing a quaternary ammonium compound into polysulfone, but has no direct influence on improvement of forward osmosis water flux.

### Experimental Example 4

### Forward Osmosis Fouling Performance

Forward osmosis fouling performance of a hybrid membrane including the membrane of Example 3 as a support layer and a polyamide separation layer is evaluated through comparison with that of a hybrid membrane including the membrane of Comparative Example 2 as a support layer and a polyamide separation layer.

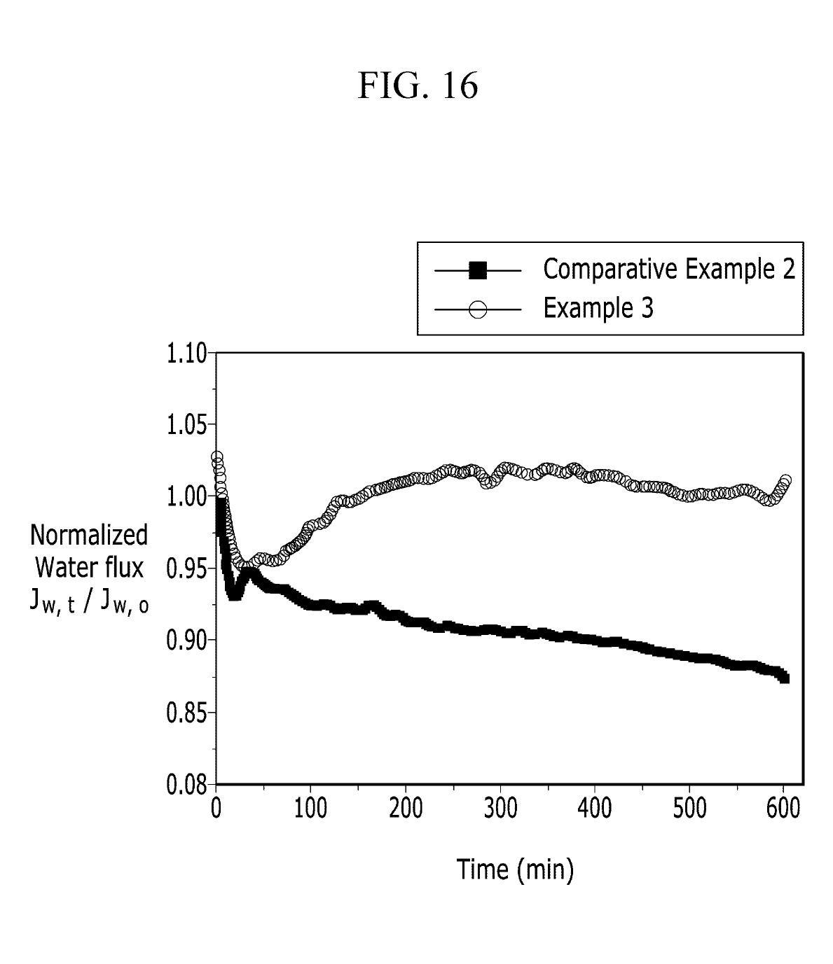

The evaluation is performed by using a 1.0 M NaCl solution as a draw solution and a BSA (bovine serum albumin) protein (0.5 g/l) solution as a feed solution, positioning the hybrid membrane as a separation layer to contact the feed solution and a non-woven fabric as a substrate for the separation membrane to contact the draw solution, and flowing the draw and feed solutions in an opposite direction at a speed of about 10.7 cm/s for 10 to 12 hours at 20° C. As a result, normalized water flux depending on time is determined, and the results are provided in FIG. 16.

As shown in FIG. 16, a separation membrane including the membrane of Example 3 as a support layer is operated without decreasing water flux even for a long term compared with a separation membrane including the membrane of Comparative Example 2, and accordingly, a separation membrane including a fouling resistant membrane according to one embodiment of the present invention shows remarkably improved fouling resistance.

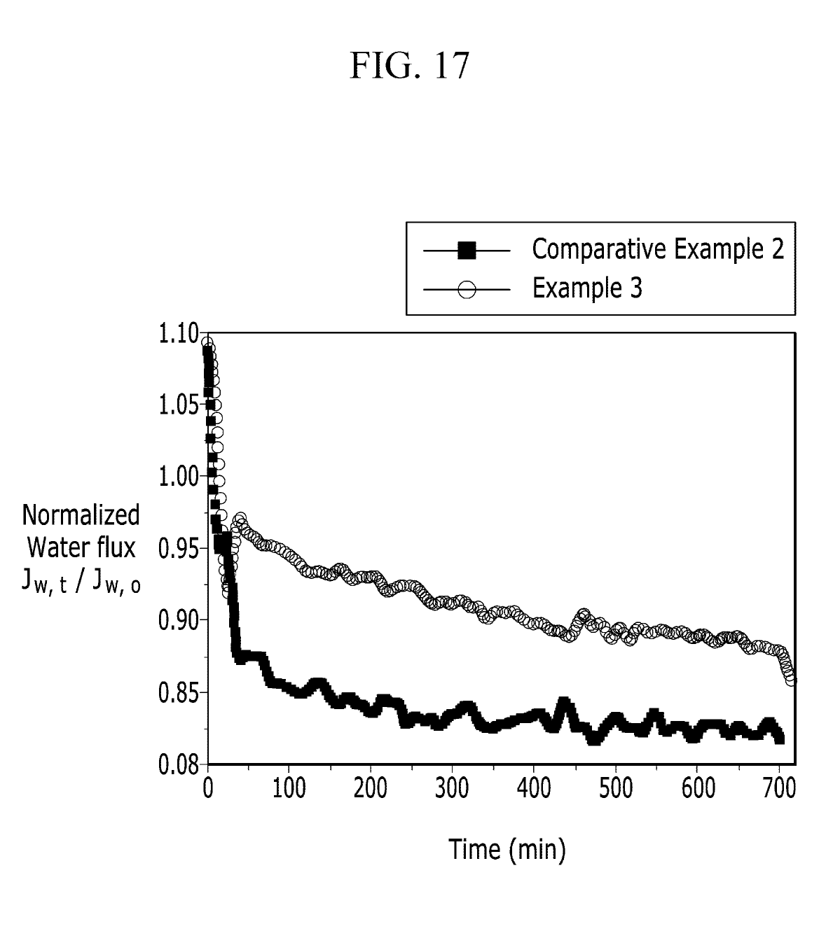

On the other hand, FIG. 17 shows water flux results depending on time by positioning a polyamide separation layer to contact a draw solution and the membrane of Comparative Example 2 or Example 3 as a support layer to contact a feed solution without a non-woven fabric under the same operation conditions. As shown in FIG. 17, the separation membrane including no non-woven fabric shows a little decreased normalized water flux compared with the separation membrane provided in FIG. 16, but a separation membrane including the membrane of Example 3 as a support layer shows more slowly decreased water flux compared with a separation membrane including the membrane of Comparative Example 2. In other words, a separation membrane including an organic/inorganic hybrid membrane for fouling resistance according to one embodiment of the present invention may be operated without decreasing water flux for a long term due to improved fouling resistance effects.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. An organic/inorganic hybrid membrane for fouling resistance comprising:
a composite dispersed in an organic polymer matrix, the composite including an inorganic nanoparticle and a quaternary ammonium compound represented by the following Chemical Formula 1 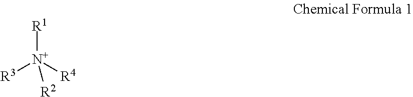
wherein, in Chemical Formula 1,
each of R¹ to R³ are the same or different, and are independently a C₁ to C₂₀ linear or branched alkyl group, and
R⁴ is —(CH₂)ₙ—SiR′, wherein R′ is one of a hydroxy group and a C₁ to C₆ alkoxy group, and n is an integer ranging from 1 to 10.

2. The organic/inorganic hybrid membrane of claim 1, wherein the inorganic nanoparticle is one of an oxide and a hydroxide including one of Ti, Al, Zr, Si, Sn, B, and Ce.

3. The organic/inorganic hybrid membrane of claim 1, wherein the compound represented by Chemical Formula 1 is 3-(trimethoxysilyl)-propyldimethyloctadecyl ammonium chloride.

4. The organic/inorganic hybrid membrane of claim 1, wherein the organic polymer matrix includes one of polysulfone, sulfonated polysulfone, polyethersulfone, polyphenylsulfone, sulfonated polyphenylsulfone, polyetherethersulfone, polyetherketone, polyetheretherketone, polyphenylene ether, polydiphenylphenylene ether, polyphenylene sulfide, cellulose acetate, cellulose diacetate, cellulose triacetate, polyacrylonitrile, a mixture of two or more thereof, and the foregoing organic polymers substituted with an anionic functional group.

5. The organic/inorganic hybrid membrane of claim 4, wherein the anionic functional group is one of a carboxyl group (—COOH), a sulfonic acid group (—SO₃H), a phosphinic group (—PO₃H₂), a phosphonic group (—HPO₃H), and a nitrous acid group (—NO₂H).

6. The organic/inorganic hybrid membrane of claim 1, wherein the composite of the inorganic nanoparticle and the quaternary ammonium compound has a core-shell structure including a core of the inorganic nanoparticle and a shell of the quaternary ammonium compound.

7. The organic/inorganic hybrid membrane of claim 1, wherein the organic/inorganic hybrid membrane has a finger-like pore structure.

8. The organic/inorganic hybrid membrane of claim 1, wherein
the inorganic nanoparticle is one of silica (SiO₂), titania (TiO₂), and a mixture thereof;
the organic polymer matrix is one of polysulfone, sulfonated polysulfone, and sulfonated polyphenylsulfoneᵢᵢ and
the compound represented by Chemical Formula 1 is 3-(trimethoxysilyl)-propyldimethyloctadecyl ammonium chloride.

9. A method of preparing an organic/inorganic hybrid membrane for fouling resistance, the method comprising:
preparing one of an inorganic nanoparticle and a precursor of the inorganic nanoparticle, and a quaternary ammonium compound of the following Chemical Formula 1;
adding the prepared one of the inorganic nanoparticle and the precursor of the inorganic nanoparticle and the quaternary ammonium compound to an organic polymer solution to prepare a mixture; and
coating the mixture on a substrate; and
applying a non-solvent induced phase-separation method to the coated substrate after the coating: 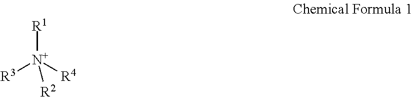
wherein, in Chemical Formula 1,
each of R¹ to R³ are the same or different, and are independently a C₁ to C₂₀ linear or branched alkyl group, and
R⁴ is —(CH₂)ₙ—SiR′, wherein R′ is one of a hydroxy group and a C₁to C₆ alkoxy group and n is an integer ranging from 1 to 10.

10. The method of claim 9, wherein the preparing prepares the inorganic nanoparticle including one of an oxide and a hydroxide including one of Ti, Al, Zr, Si, Sn, B, and Ce.

11. The method of claim 9, wherein the preparing prepares the precursor of the inorganic nanoparticle including one of an alkoxide, an ester, an acetylacetonate, a halide, and a nitride including one of Ti, Al, Zr, Si, Sn, B, and Ce.

12. The method of claim 9, wherein the preparing forms a composite of an inorganic nanoparticle-quaternary ammonium compound by coating the surface of the inorganic nanoparticle with the quaternary ammonium compound.

13. The method of claim 9, wherein the preparing prepares the precursor of the inorganic nanoparticle and the quaternary ammonium compound.

14. The method of claim 9, wherein the preparing prepares the inorganic nanoparticle including one of silica (SiO₂), titania (TiO₂), and a mixture thereof, and the compound of Chemical Formula 1 including 3-(trimethoxysilyl)-propyldimethyloctadecyl ammonium chloride.

15. The method of claim 9, wherein the adding adds the prepared one of the inorganic nanoparticle and the precursor of the inorganic nanoparticle and the quaternary ammonium compound to the organic polymer solution including one of polysulfone, sulfonated polysulfone, and sulfonated polyphenylsulfone.

16. A separation membrane for water treatment comprising the organic/inorganic hybrid membrane of claim 1.

17. The separation membrane of claim 16, further comprising:
a separation layer on one surface of the organic/inorganic hybrid membrane, the separation layer being a semi-permeable membrane permeating water and not permeating impurities to be removed.

18. A water treatment device comprising the separation membrane of claim 16.
